(19) United States
(12) Patent Application Publication
(10) Pub. No.: US 2014/0032396 A1
(43) Pub. Date: Jan. 30, 2014

(54) SYSTEM AND METHOD FOR TRACKING BANK NOTES

(71) Applicants: Jun Sheng, Lewisville, TX (US); Sohail Kayani, Irving, TX (US)

(72) Inventors: Jun Sheng, Lewisville, TX (US); Sohail Kayani, Irving, TX (US)

(21) Appl. No.: 13/557,816

(22) Filed: Jul. 25, 2012

(51) Int. Cl. H04Q 5/22; G07F 7/04; G06Q 20/04

(52) U.S. Cl. 705/39; 340/10.4; 194/206

(57) ABSTRACT

A bank note processing machine is disclosed that includes a note counter, wherein the note counter counts bank notes in a bundle of bank notes and generates one or more determined characteristics for the bundle of bank notes; and an RFID reader, wherein the RFID reader detects information from an RFID chip associated with the bundle of bank notes, the detected information comprising one or more supplied characteristics of the bundle of bank notes. The one or more determined characteristics can include at least one of number of bank notes in the bundle of bank notes, denomination of bank notes in the bundle of bank notes, and total amount of money in the bundle of bank notes.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE DISCLOSURE

1. Field of the Disclosure

The present disclosure relates to automated currency processing and, more specifically, to the automated identification and tracking of bank notes.

2. Description of Related Art

Automated processing of large volumes of currency is an important part of numerous aspects of the distribution, collection, and accounting of paper currency. It is desirable to perform the processing of currency in an efficient manner while taking into account the various associated security considerations. The processing of currency may entail a number of steps, including, but not limited to, collection of notes by a teller or cashier; accounting of individual commercial deposits or bank teller pay-in accounts, transfer of deposits to a central processing facility, handling of the deposits upon arrival at the processing facility, and the processing of individual accounts through automated processing machines.

Automation of these tasks and elimination of human involvement in the process is beneficial as it is likely to improve accuracy, enhance efficiency, and reduce the likelihood of security concerns such as theft, inadvertent loss or mishandling of currency. When transferring bank notes from one entity to another (e.g. from a bank branch to a branch of the Federal Reserve Bank) it is important to keep track of the bank notes being transferred. Typically, an individual at the sending entity counts the bank notes and places them in a bag that is marked with the amount of currency contained therein. Upon receipt, an individual at the receiving entity opens the bag and counts the bank notes to ensure that the amount in the bag matches the amount denoted thereon.

Additionally, many entities such as national central banks, independent currency transporting companies, currency printing facilities, and individual banks may utilize different automated currency processing machines to confirm that the bag contains the amount of currency denoted thereon. Once the receiving entity confirms that the amount of currency in the bag matches the amount denoted on the bag, that amount will be credited to the sending entity. Generally, an automated currency processing machine may include a conveyor system that may transport a note past one or more detectors. For example, the note may be passed through a series of electrical transducers designed to measure the note's width, length, and thickness. The note may also be passed through other detectors such as, for example, optical sensors that record the note's color patterns and other detectors that may detect the note's magnetic or other physical characteristics. The information gathered by the sensors may then be used to facilitate the sorting of the individual notes and the accumulation of data regarding each note that passes through the automated mechanism. For instance, the automated currency processing machine may process a bundle of bank notes to ensure that it is all of one denomination with acceptable fitness characteristics or it may separate a bundle of bank notes into individual denominations, while simultaneously counting the stack to confirm a previous accounting. The automated currency processing machine may also reject any currency that does not meet fitness specifications, identify any counterfeit bills, and/or track individual notes by serial number.

Typically, an automated currency processing machine may be loaded with a single stack of currency at a time that is associated with a single set of accounting parameters before executing the sort process. That stack may then be fed into the automated currency processing machine and be sorted based on customer needs. The data obtained by the automated currency processing machine from the sort process, for example, the number of each denomination note detected and/or the total deposit amount, may then be compared to the same data identified to the bundle of bank notes prior to the processing cycle.

In order to improve efficiency and accuracy and reduce security risks, it is desirable to develop an automated process for keeping track of bank notes transferred between different entities and reconciling accounts associated with those transfers.

### BRIEF DESCRIPTION OF THE SEVERAL VIEWS OF THE DRAWING(S)

The present disclosure will be more fully understood by reference to the following detailed description of the preferred embodiments of the present disclosure when read in conjunction with the accompanying drawings, in which like reference numbers refer to like parts throughout the views, wherein:

FIG. 1 depicts an illustrative block diagram of entities involved in transfer of bank notes.

FIG. 2 depicts a block diagram of a bank note processing machine in accordance with an embodiment of the present disclosure;

FIG. 3 depicts an illustrative batch of currency that may be handled in accordance with the present disclosure;

FIG. 3A depicts another illustrative batch of currency that may be handled in accordance with the present disclosure;

FIG. 3B depicts yet another illustrative batch of currency that may be handled in accordance with the present disclosure;

FIG. 4 is a flowchart representing the processing steps in accordance with one embodiment of the present disclosure; and

FIG. 5 is a flowchart representing the processing steps in accordance with another embodiment of the present disclosure.

The disclosure may be embodied in other specific forms without departing from the spirit or essential characteristics thereof. The present embodiments are therefore to be considered in all respects as illustrative and not restrictive, the scope of the disclosure being indicated by the appended claims rather than by the foregoing description, and all changes which come within the meaning and range of equivalency of the claims are therefore intended to be embraced therein.

### DETAILED DESCRIPTION OF THE DISCLOSURE

The present disclosure utilizes a novel method for monitoring and processing large volumes of currency at high speed while keeping track of the specific accounting parameters that the currency corresponds to.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (“EEPROM”), and/or flash memory; as well as communications media such as wires, optical fibers, microwaves, radio waves, and other electromagnetic and/or optical carriers; and/or any combination of the foregoing.

The terms “couple” or “couples” as used herein are intended to mean either an indirect or direct connection. Thus, if a first device couples to a second device, that connection may be through a direct connection, or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

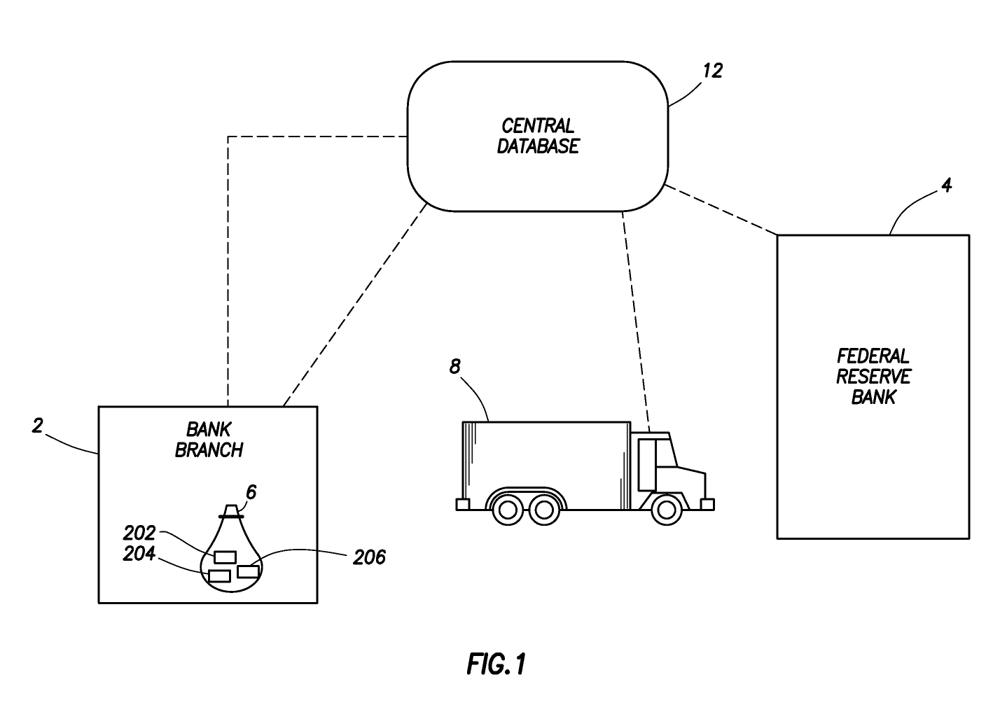

FIG. 1 depicts a general process for transferring bank notes from a sending entity 2 to a receiving entity 4. In the illustrative embodiment of FIG. 1, the sending entity 2 may be a bank branch and the receiving entity 4 may be a branch of the Federal Reserve Bank. Although the present disclosure will be discussed in conjunction with transfer of bank notes from a bank branch 2 to the Federal Reserve Bank 4, the present disclosure is not limited to this particular application and may be utilized when transferring bank notes between any two or more entities.

In accordance with an embodiment of the present disclosure, prior to sending a bag 6 containing a plurality of bundles of bank notes 202, 204, 206, the bank branch 2 determines the number and characteristics of the bank notes in each bundle. In one embodiment, the bank branch 2 may determine the number and denomination of the notes in each bundle 202, 204, 206. In certain embodiments, a bank note processing machine may be used to determine the characteristics of the bank note bundles.

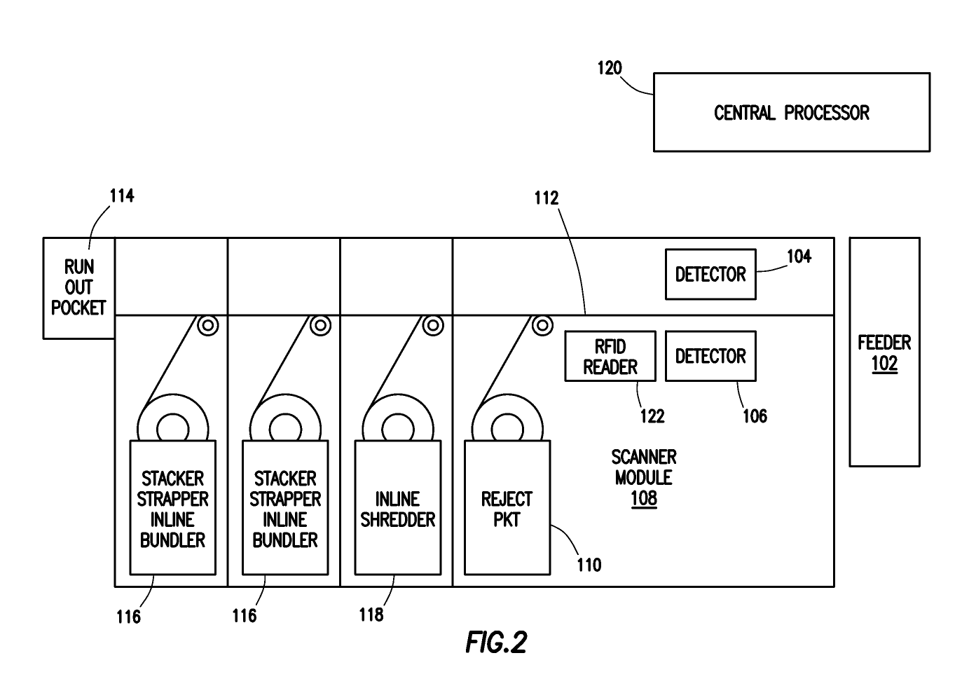

FIG. 2 depicts a block diagram of a bank note processing machine according to one embodiment of the present disclosure, highlighting the location of the detectors with respect to the processing stream. A bank note is first stripped from a stack of notes in the feeder 102 and sent along the transport path to the scanner module 108. Within the scanner module 108 is an area centered on the transport path in which one or more detectors 104, 106 may be located. A transport device 112 is coupled to the feeder 102. The transport device 112 provides a path along which notes travel past the detectors 104, 106. Any number of detectors may be utilized, such as, for example, optical detectors and/or ultrasonic detectors to identify damaged notes or other desirable characteristics. One or more detectors may be used as a note counter and/or denomination counter or detector. The note counter counts the number and or denomination of bank notes in a bundle of bank notes. The number of bank notes in the bundle of bank notes may then be used in conjunction with information regarding the denomination of the bank notes to determine the amount of money in the bundle of bank notes. Moreover, any damaged notes identified may be directed to a designated pocket 110 where they may be replaced with new notes and then be rejected or they may be directed to an inline shredder 118 where they are shredded. Additionally, as discussed above, the detectors may identify the denomination of each note, may keep track of the accounting parameters of the particular bundle, and/or may identify counterfeit notes. The notes that are not collected in the pocket 110 or shredded by the inline shredder 118 may then be directed to a final disposition component, which typically comprises a pocket 114 for collection of processed notes, one or more strappers 116 for strapping the notes in bundles, and a means for depositing the notes into the pocket by pulling the notes from the note processing path or transport device. In addition, a bundle of bank notes with rejected notes could be reprocessed by the machine to confirm the initial count. This reprocessing could occur by having an operator rerun the bundle. After reprocessing, the central processor may record and process the rejection and count information. In the alternative, information regarding rejected notes could be manually entered into a database by an operator. Processing of the bank notes may be controlled by a central processor 120, which may be an information handling system that controls the timing of the system as well as activation of the detectors, processing of data collected by the detectors, and/or control of the note disposition. Although the central processor 120 is shown as a single unit in FIG. 1, as would be appreciated by those of ordinary skill in the art with the benefit of this disclosure, the central processor 120 may comprise of one or more information handling systems that are communicatively coupled and operate in tandem. In accordance certain embodiments, the bank note processing machine may also include an RFID reader 122. The operation of the RFID reader 122 will be discussed in more detail below.

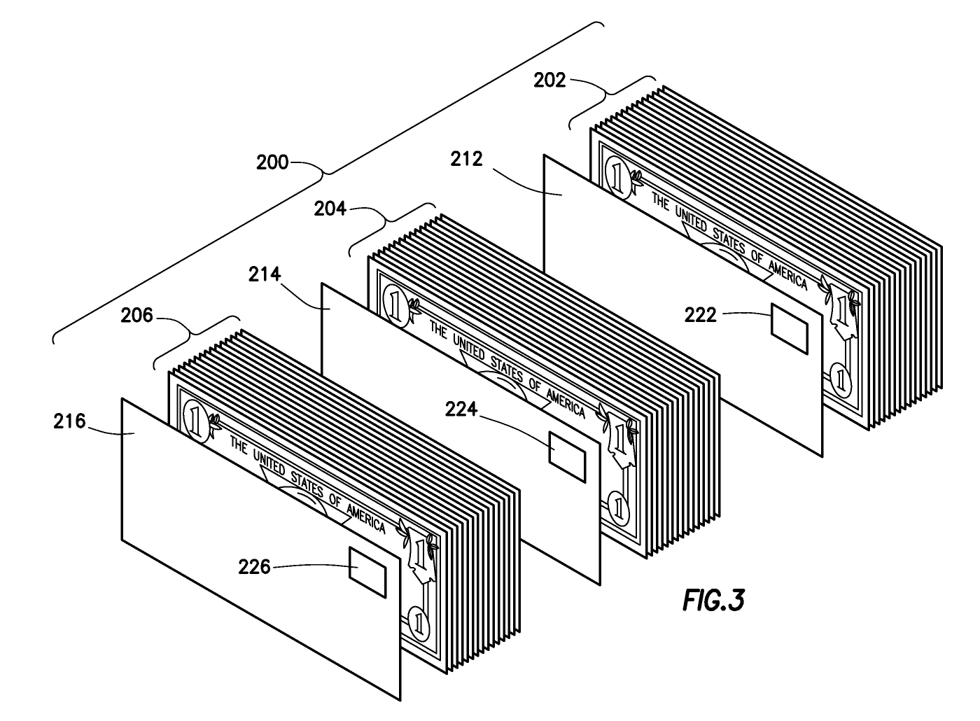

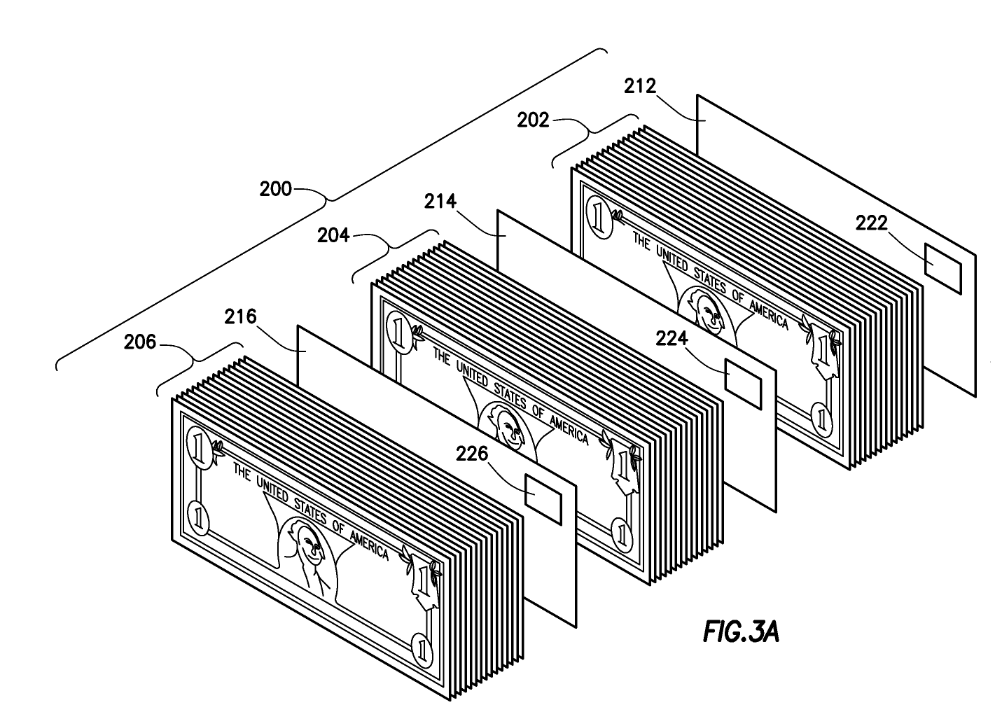

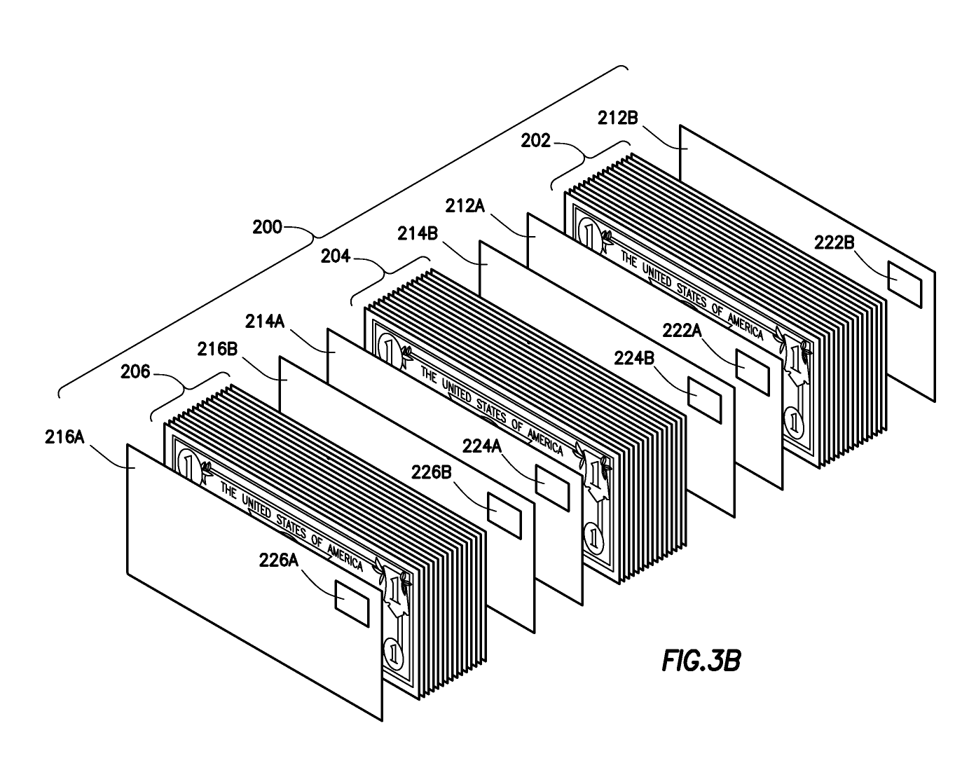

FIG. 3 depicts a batch of currency 200 corresponding to the bundles of bank notes in the bag 6 of FIG. 1 in accordance with an illustrative embodiment of the present disclosure. The batch of currency 200 may be comprised of three distinct bundles of bank notes 202, 204, 206, each having its own individual accounting parameters. A separator tag 212, 214, 216 is associated with each distinct bundle of bank notes 202, 204, 206, respectively. The combination of each bundle of bank notes 202, 204, 206 with its corresponding separator tag 212, 214, 216 forms a stack module. In one embodiment, the separator tags 212, 214, 216 may be made of a suitable polymer material and each may be embedded with a corresponding Radio-Frequency Identification (“RFID”) chip 222, 224, 226. The RFID chip includes a computer-readable medium which can store a host of information regarding the distinct bundle of bank notes 202, 204, 206 corresponding to the particular RFID chip 222, 224, 226.

Returning to FIG. 1, once the bank branch 2 has processed the bundles of bank notes 202, 204, 206 in the bag 6 and determined the characteristics of the bundles, those characteristics may be stored in the RFID chip 222, 224, 226 corresponding to the bundle of bank notes. Specifically, the RFID chip 222, 224, 226 may store the individual accounting parameters of the particular bundle of bank notes associated therewith. The individual accounting parameters stored in each RFID chip may include, but are not limited to, the identity of the sender of the particular bundle of bank notes such as the particular teller or financial institution associated with the bundle of bank notes; the amount or total monetary value of the particular bundle of bank notes as determined by the sender; the denominations of the bank notes included in the bundle of bank notes as determined by the sender; a particular RFID identifier to be able to track a particular bundle of bank notes; routing information for the bank notes; identity of the individuals that put the bundle of bank notes together or placed it in the bag; and other information regarding the particular bundle of bank notes that are deemed desirable. This information is referred to herein as the “supplied characteristics”.

In certain embodiments, instead of including all the supplied characteristics of the bundle of bank notes on the RFID chip, the RFID chip may only include a specific RFID number stored in a computer-readable medium. One or more of the supplied characteristics listed above may then be linked to the specific RFID number in a computer-readable medium which may be located separate from the RFID chip. For instance, in certain embodiments, the central processor 120 may have access to a database reflecting the supplied characteristics for a bundle of bank notes corresponding to a specific RFID number. The RFID number may, for instance, be associated with a range of RFID numbers assigned to a branch bank or other entity. Then, once the RFID number of a particular RFID chip is identified (as discussed in more detail below), the central processor 120 can readily obtain the supplied characteristics associated with that particular RFID number relating to the bundle of bank notes.

Although the separator tags 212, 214, 216 are placed in front of the bundles of bank notes in the embodiment of FIG. 3, in other embodiments the separator tags 212, 214, 216 may be placed behind the bundles of bank notes as shown in FIG. 3A. Moreover, in accordance with certain embodiments as shown in FIG. 3B, a pair of separator tags (denoted as 212A and B, 214A and B and 216A and B) may be associated with each bundle of bank notes denoting the beginning and the end of the stack, with each of them having a corresponding RFID chip (denoted as 222A and B, 224A and B and 226A and B). In each case, a stack module is formed which comprises of a bundle of bank notes and its associated separator tag or tags.

Returning now to FIG. 1, a delivery service 8 may be used to transfer the bag 6 from the bank branch 2 to the Federal Reserve Bank 4. In certain embodiments, the delivery service 8 may be a truck. In one embodiment, prior to delivering the bag 6 to the truck 8, the identification of the RFID chips 222, 224, 226 and the corresponding supplied characteristics of the bundle of bank notes 202, 204, 206 associated with each RFID chip may be supplied to a Central Database 12 that is communicatively coupled to the bank branch 2, the truck 8 and the Federal Reserve Bank 4. Specifically, the bank note processing machine utilized at the bank branch 2 may include a transmitter to transmit the RFID information together with the supplied characteristics of bundles of bank notes to the Central Database 12. The bag 6 may be sealed prior to delivery to the truck 8 by the bank branch 2. The truck 8 may then deliver the bag 6 to the Federal Reserve Bank 4. Upon receipt, the Federal Reserve Bank may first inspect the bag 6 to ensure that the seal of the bank branch 2 has remained intact.

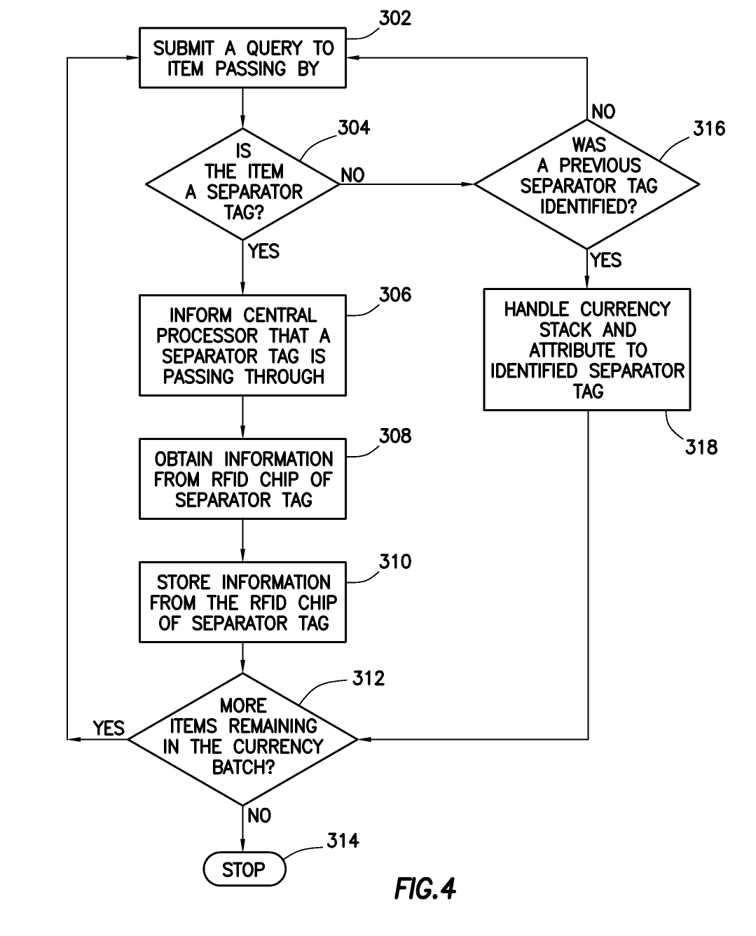

The bundles of bank notes 202, 204, 206 are then directed through a bank note processing machine at the Federal Reserve Bank 4. The bank note processing machine at the Federal Reserve Bank may resemble that shown in FIG. 2. Returning now to FIG. 2, once the batch of currency 200 is fed into the bank note processing machine, the transport device 112 will direct the contents thereof through the bank note processing machine. FIG. 4 depicts process steps in accordance with an embodiment of the present disclosure. The exemplary batch of currency depicted in FIG. 3 is used to explain the process steps disclosed herein for illustrative purposes only. However, the methods and systems disclosed herein are not limited to any specific arrangement of the bank notes and/or separator tags in a batch of currency and are applicable to any arrangement of a stack module.

For the purposes of illustration only, assume that the batch of currency 200 of FIG. 3 is fed into the bank note processing machine of FIG. 2 with the separator tag 216 being the first item that enters the bank note processing machine through the transport device 112 followed by the bundle of bank notes 206, the separator tag 214, the bundle of bank notes 204, the separator tag 212 and the bundle of bank notes 202.

First at step 302, the RFID reader 122 submits a query to the item that passes by it along the transport device 112. Using the illustrative example of the batch of currency 200 of FIG. 3, the first item that the RFID reader 122 queries will be the separator tag 216. Next, at step 304, it is determined if the item passing by the RFID reader 122 is a bank note or a separator tag. Because the bank notes do not have a RFID chip, they will not respond to the query by the RFID reader 122 whereas the separator tags include an RFID chip and will therefore respond to the RFID reader's 122 query. If the item passing by the RFID reader 122 is not a separator tag, the process returns to step 302 and the RFID reader 122 continues to make queries until a separator tag is identified. In the illustrative example using the batch of currency 200 of FIG. 3, because the first item passing by the RFID reader 122 is a separator tag 216 with an RFID chip 226, it will be identified as such and the process proceeds to step 306.

Once the RFID reader 122 determines that a separator tag is passing by it, the process proceeds to step 306 where the RFID reader 122 informs the central processor 120 that a separator tag has been identified. Once the central processor 120 is informed that the item passing through is a separator tag and not a bank note, the central processor 120 ensures that the passage of the separator tag does not interfere with the bank note processing machine. For instance, because the separator tag does not have the same characteristics as the bank notes, absent an intervention by the central processor, one or more detectors of the bank note processing machine may treat the separator tag as an unfit bank note or it may be taken out of the stack. However, such issues are avoided by informing the central processor 120 that the item passing through the bank note processing machine is a separator tag and not a bank note. In the illustrative example using the batch of currency 200 of FIG. 3, the central processor 120 is informed that a separator tag 216 is passing through the bank note processing machine.

Next, at step 308, in response to the query by RFID reader 122, the RFID chip of the separator tag transmits the information stored on a computer-readable medium therein to the RFID reader 122. In the illustrative example using the batch of currency 200 of FIG. 3, the RFID reader 122 obtains information from the RFID chip 226 of the separator tag 216 regarding the bundle of bank notes 206. The information obtained is information relating to the bundle of bank notes that is provided by the sender of the bundle of bank notes (i.e. the bank branch 2 in the illustrative embodiment). As set forth above, the supplied characteristics from the RFID chip 226 may include, but is not limited to, information regarding the sender of the particular bundle of bank notes such as the particular teller or financial institution associated with the bundle of bank notes; the amount of the particular bundle of bank notes as determined by the sender; the denominations of the bank notes included in the bundle of bank notes as determined by the sender; and other information regarding the particular bundle of bank notes.

Next, at step 310 the RFID reader 122 and/or the central processor 120 may store the information obtained from RFID chip of the separator tag in a computer-readable medium. In the illustrative example using the batch of currency 200 of FIG. 3, the information obtained from the RFID chip 226 of the separator tag 216 is stored in a computer readable medium.

Once the information from the RFID chip 226 is stored at step 310, at step 312 it is determined if there are more items remaining in the batch of currency. If there are no more items remaining in the batch of currency then the process will terminate at step 314 because all the notes and separator tags in the batch of currency 200 have already been accounted for. If there are items remaining in the batch of currency, the process returns to step 302 and the RFID reader 122 submits a query to the next item passing by. In the illustrative example using the batch of currency 200 of FIG. 3, there are more items remaining in the batch of currency 200 after the separator tag 216 and therefore, the process returns to step 302 and the RFID reader 122 submits a query to the next item passing by it. However, the next item is a bank note from the bundle of bank notes 206 and not a separator tag.

Returning now to step 304, if it is determined that the item being queried by the RFID reader 122 is not a separator tag, the process continues to step 316 to determine if a previous separator tag was detected. If no separator tag was previously detected that indicates that no separator tags were used for the particular bundle of bank notes and so the process returns to step 302 to find the next separator tag. In contrast, if at step 304 it is determined that the current item is not a separator tag and at step 316 it is determined that a previous separator tag was identified, the process continues to step 318. In the illustrative example using the batch of currency 200 of FIG. 3, once the separator tag 216 passes through, the following items are the bank notes of the bundle of bank notes 206. The bank notes of the bundle of bank notes 206 are not separator tags and will not respond to the query by the RFID reader 122. However, a previous separator tag 206 was detected before these bank notes pass through the RFID reader 122. Therefore, with respect to the illustrative example using the batch of currency 200 of FIG. 3, for each of the bank notes of the bundle of bank notes 206, the process continues to step 318.

At step 318, the central processor 120 attributes the bank note currently passing through the bank note processing machine to the previous separator tag that has been identified by the RFID reader 122. In the illustrative example using the batch of currency 200 of FIG. 2, once the separator tag 216 is identified, the central processor 120 recognizes that the bank notes of the bundle of bank notes 206 correspond to the separator tag 216. Accordingly, the central processor 120 attributes the bank notes of the bundle of bank notes 206 to the separator tag 216. Specifically, the central processor 120 may store the information regarding the number of notes in the bundle of bank notes 206, the denomination of the bank notes in the bundle of bank notes 206, the amount of money in the bundle of bank notes 206, the fitness characteristics of the bank notes in the bundle of bank notes 206, the existence of counterfeit bank notes in the bundle of bank notes 206 and other desired information relating to the bundle of bank notes 206. This information may be stored as the characteristics of the bundle of bank notes 206 determined by the bank note processing machine in a computer-readable medium by the central processor 120 and is referred to herein as the bundle of bank notes' “determined characteristics”.

The process then returns to step 312 to determine if there are more items remaining in the batch of currency. Once there are no more items remaining in the batch of currency, the process terminates at step 314.

Accordingly, by the time the process terminates at step 314, the central processor has received the information on the RFID chip of each bundle of bank notes of the batch of currency and has processed the bank notes in each of the stacks. The central processor 120 has also associated the supplied characteristics (e.g., amount, denomination and other characteristics of each stack) with its corresponding separator tag. Thus, the central processor 120 can now compare the results of its processing (i.e. the determined characteristics) for each bundle of bank notes with the information provided in the RFID chip of the separator tag of each stack as provided by the sender. In certain embodiments, rather than containing the supplied characteristics locally on the RFID chip, the supplied characteristics may instead be stored in a central database 12. The central database 12 may be comprised of a computer-readable medium and may be part of an information handling system. The central processor 120 of the bank note processing machine at the Federal Reserve Bank 4 may be communicatively coupled to that central database 12 and the RFID chip associated with each bundle of bank notes 202, 204, 206 may include a pointer to the supplied characteristics.

By comparing this information, the central processor at the Federal Reserve Bank 4 can determine if there is a discrepancy between the one or more supplied characteristics provided by the separator tag and the one or more determined characteristics obtained by the detectors of the bank note processing machine. Stated otherwise, the central processor 120 may generate comparison information by comparing the supplied characteristics of each bundle of bank notes with its determined characteristics. For instance, these discrepancies may include, but are not limited to, whether there are any discrepancies between the amount of money the sender indicated was included in each stack and the amount of money accounted for by the bank note processing machine; whether the denominations of the bank notes of each bundle of bank notes are consistent with the denominations of the bank notes of that bundle of bank notes as reported by the sender; and whether there were any counterfeit bank notes in the processed stack and if so, who was the sender of the stack that contained the counterfeit bank notes. If there is a discrepancy between the determined characteristics and the supplied characteristics the central processor may issue a notification. In certain embodiments, the central processor 120 may be communicatively coupled to a transmitter, enabling the central processor 120 to transmit the determined characteristics, the supplied characteristics as determined using the information on the RFID chip and/or the comparison information to the sending entity (bank branch 2), central database 12 or another information handling system.

In certain embodiments, the issued notification from the central processor 120 may then be reported to the sender which may be an individual or a financial institution. In certain embodiments, the central processor 120 or another information handling system may directly notify the sender of any such discrepancies based on the result of processing by the bank note processing machine. For instance, the sender may be notified by electronic mail or other wired or wireless communication methods or the discrepancies may be loaded onto a computer-readable medium and delivered to the sender. In this and other embodiments, the account of the sender that is maintained at the central bank or counting facility is debited or credited depending on any counting discrepancy.

In the illustrative embodiment of FIG. 1 where the sending entity is a bank branch 2 and the receiving entity is the Federal Reserve Bank 4, the Federal Reserve Bank 4 may use any detected notifications to automatically keep track of transactions with the particular bank branch 2 and reconcile its account with the bank branch 2. For instance, if the supplied characteristics of a bundle of bank notes states that the bundle includes twenty $1 notes and the determined characteristics indicate that in fact, there are only nineteen $1 notes, the comparison information would indicate that the bank branch 2 owes the Federal Reserve Bank 4 $1. In the same manner, any discrepancies between the determined characteristics and the supplied characteristics of the bundles of bank notes are automatically used to reconcile the account balance between the bank branch 2 and the Federal Reserve Bank 4. Accordingly, if the amount of money in a bundle of bank notes as indicated by the determined characteristics is less than the amount of money in the bundle of bank notes as indicated by the supplied characteristics, the Federal Reserve Bank 4 may debit the bank branch's 2 account. In contrast, if the amount of money in a bundle of bank notes as indicated by the determined characteristics is more than the amount of money in the bundle of bank notes as indicated by the supplied characteristics, the Federal Reserve Bank 4 may credit the bank branch's 2 account.

Moreover, if the determined characteristics indicate that one or more bank notes in the bundle of bank notes failed to meet one or more threshold parameters and are therefore deemed unfit, the central processor may issue a notification to that effect. For instance, a bank note may be deemed unfit if it fails to meet the minimum acceptable fitness characteristics (e.g. the note was torn, soiled, or otherwise unacceptable) or if it is a counterfeit bank note. The notification issued by the central processor may include information regarding the reason the bank note is deemed unfit and/or the number of unfit bank notes in the bundle of bank notes.

Accordingly, with respect to the illustrative example using the batch of currency 200 of FIG. 3, the process of FIG. 4 is performed in the same manner as discussed above in conjunction with separator tag 216 and bundle of bank notes 206 for the remaining stack modules (i.e. separator tags (214, 212) and bundles of bank notes (202, 204)). Consequently, by the time the process of FIG. 4 terminates at step 314, the central processor 120 would have access to computer readable media that include two sets of information. The first set of information is the information relating to each bundle of bank notes 202, 204, 206 as provided by the sender in the RFID chip 222, 224, 226 of the separator tag 212, 214, 216. This information is what is referred to herein as the supplied characteristics. Additionally, for each bundle of bank notes 202, 204, 206 the central processor 120 has access to determined characteristics obtained by processing the bank notes through the bank note processing machine.

If it is determined that there are no discrepancies between the determined characteristics of the bundle of bank notes and the supplied characteristics of the bundle of bank notes, the bank notes of each bundle of bank notes may be bundled and/or otherwise grouped together and credited to the sender. In the illustrative embodiment of FIG. 1, the Federal Reserve Bank 4 credits the bank branch's 2 account for the amount of money corresponding to the bundle of bank notes.

In certain embodiments, in addition to information stored in the computer readable medium in the RFID chips 222, 224, 226 of the separator tags 212, 214, 216, the separator tags 212, 214, 216 may also include written information thereon. Specifically, some of the information relating to the particular bundle of bank notes corresponding to the separator tag may be written on the separator tag 212, 214, 216 to permit visual inspection of the information. In these embodiments, one of the detectors 104, 106 may be an optical detector such as, for example, a camera. The camera can then capture an image of the information written on the separator tag and the captured image may be interpreted by the bank note processing machine. In certain embodiments, Optical Character Recognition (“OCR”) technology may be used to process the captured images. The use of OCR technology is well known to those of ordinary skill in the art and will therefore not be discussed in detail herein.

In one embodiment, the central processor 120 which as discussed above, may be an information handling system, may have access to a computer-readable medium which contains instructions allowing the central processor 120 to automate the methods disclosed herein. Specifically, the central processor may use the instructions in the computer-readable medium to control the operation of the various system components (e.g., the feeder, the transport device, the RFID reader, the detectors, etc.), store information relating to the batch of currency in a computer-readable medium or transmit notifications to predetermined individuals and/or entities if there are discrepancies between the supplied characteristics and the determined characteristics.

As would be appreciated by those of ordinary skill in the art, with the benefit of this disclosure, the process of FIG. 4 may be modified to facilitate handling of different stack module configurations such as a stack module where the separator tag follows its associated bundle of bank notes or where a pair of separator tags are used with the bundle of bank notes placed between them as shown in FIGS. 3A and 3B, respectively.

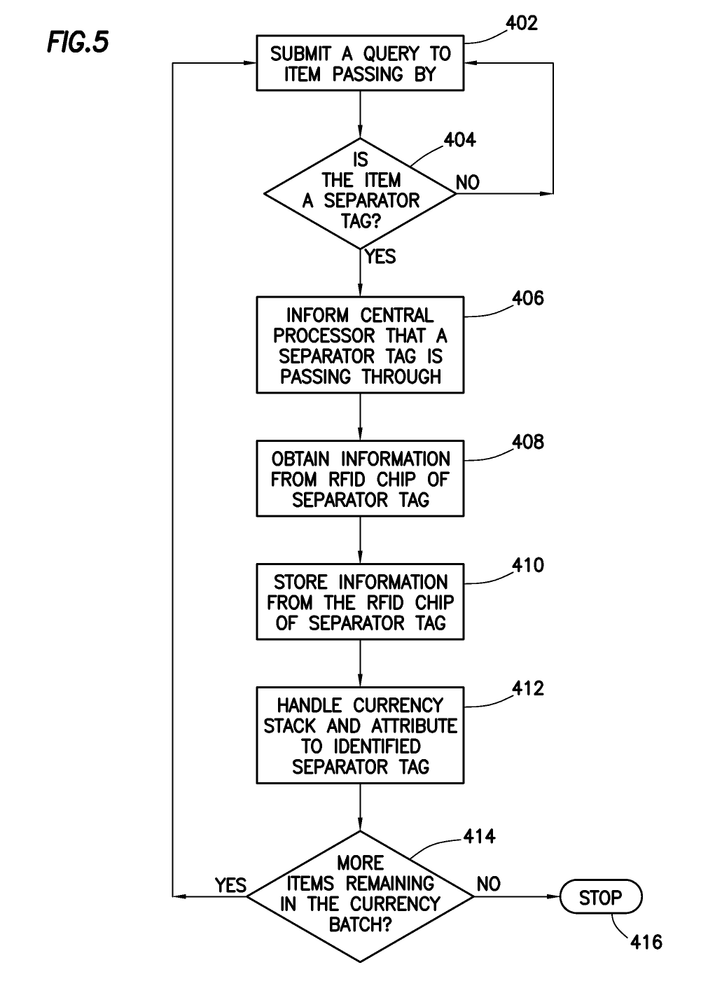

Specifically, FIG. 5 depicts the process flow of FIG. 4 as modified when using a stack module with a separator tag positioned behind each bundle of bank notes as shown in the illustrative embodiment of FIG. 3A. First at step 402, the RFID reader 122 submits a query to the item that passes by it along the transport device 112. Next, at step 404, it is determined if the item passing by the RFID reader 122 is a bank note or a separator tag. If the item is a bank note, that means the end of the bundle of bank notes has not been reached yet and the process returns to step 402. Steps 402 and 404 are repeated until the RFID reader 122 identifies a separator tag. The process then proceeds to step 406 where the RFID reader 122 informs the central processor 120 that a separator tag has been identified. Once the central processor 120 is informed that the item passing through is a separator tag and not a bank note, the central processor 120 ensures that the passage of the separator tag does not interfere with the bank note processing machine in the same manner as discussed above in conjunction with FIG. 4.

Next, at step 408, in response to the query by RFID reader 122, the RFID chip of the separator tag transmits the supplied characteristics stored in its computer-readable medium to the RFID reader 122 in the same manner discussed above with respect to FIG. 4. At step 410, the RFID reader 122 and/or the central processor 120 may store the information obtained from RFID chip of the separator tag in a computer-readable medium. Finally, because the separator tag is placed at the end of the stack module, at step 412 the determined characteristics of the bundle of bank notes are attributed to the identified separator tag. At step 414 it is determined if there are more items remaining in the batch of currency in the feeder. If not, the process terminates at step 416. In contrast, if there are additional items remaining in the feeder, the process returns to step 402 and is repeated for the subsequent stack module.

In other embodiments, a stack module as shown in FIG. 3B may be monitored using the methods and systems disclosed herein. Specifically, as would be appreciated by those of ordinary skill in the art, a separator tag may be positioned on either end of the bundle of bank notes to designate the beginning and ending of the bundle of bank notes. The processes set forth in FIGS. 4 and 5 may be modified to monitor such a stack module. Specifically, if the separator tag at the end of the bundle of bank notes contains the supplied characteristics, the process set forth in FIG. 4 may be utilized with an additional step to identify the beginning of a stack module when the RFID chip of the separator tag at the beginning of the stack module reaches the RFID reader 122 and responds to its query. In contrast, if the separator tag in front of the bundle of bank notes contains the supplied characteristics, the process set forth in FIG. 5 may be utilized with an additional step to identify the end of the stack module when the RFID chip of the separator tag at the end of the stack module reaches the RFID reader 122 and responds to its query. Alternatively, as would be appreciated by those of ordinary skill in the art, with the benefit of this disclosure, some of the supplied characteristics may be stored on the RFID chip of the separator tag in front of the bundle of bank notes and other supplied characteristics may be stored on the RFID chip of the separator tag at the back of the bundle of bank notes. In this embodiment, a combination of the process steps set forth in FIGS. 4 and 5 may be utilized to handle the bundle of bank notes.

Accordingly, in one embodiment, the bank note processing machine may have different modes that can be selected by a user, with each mode corresponding to a different configuration of the stack module. The user may then select the appropriate mode of operation depending on the configuration of the stack module of the batch of currency that is going to be fed to the bank note processing machine which is known.

Although a number of steps are set forth in FIGS. 4 and 5, as would be appreciated by those of ordinary skill in the art, the methods disclosed herein may be carried out without performing every step identified in the Figures. Moreover, additional steps may be used in the process without departing from the scope of the present disclosure.

Therefore, the present disclosure is well-adapted to carry out the objects and attain the ends and advantages mentioned as well as those which are inherent therein. While the disclosure has been depicted and described by reference to exemplary embodiments of the disclosure, such a reference does not imply a limitation on the disclosure, and no such limitation is to be inferred. The disclosure is capable of considerable modification, alteration, and equivalents in form and function, as will occur to those ordinarily skilled in the pertinent arts and having the benefit of this disclosure. The depicted and described embodiments of the disclosure are exemplary only, and are not exhaustive of the scope of the disclosure. Consequently, the disclosure is intended to be limited only by the spirit and scope of the appended claims, giving full cognizance to equivalents in all respects. The terms in the claims have their plain, ordinary meaning unless otherwise explicitly and clearly defined by the patentee.

1. A bank note processing machine comprising:
a note counter,
wherein the note counter counts bank notes in a bundle of bank notes and generates one or more determined characteristics for the bundle of bank notes; and
an RFID reader,
wherein the RFID reader detects information from an RFID chip associated with the bundle of bank notes, the detected information comprising one or more supplied characteristics of the bundle of bank notes.

2. The bank note processing machine of claim 1, wherein the one or more determined characteristics comprise at least one of number of bank notes in the bundle of bank notes, denomination of bank notes in the bundle of bank notes, and total amount of money in the bundle of bank notes.

3. The bank note processing machine of claim 1, wherein the RFID chip contains at least one of the one or more supplied characteristics of the bundle of bank notes and a pointer to the one or more supplied characteristics of the bundle of bank notes.

4. The bank note processing machine of claim 3, further comprising a central processor, wherein the central processor generates comparison information by comparing the one or more determined characteristics of the bundle of bank notes with the one or more supplied characteristics of the bundle of bank notes.

5. The bank note processing machine of claim 4, further comprising a transmitter for transmitting the comparison information to an information handling system.

6. The bank note processing machine of claim 4, wherein the central processor is operable to reconcile an account based on the comparison information.

7. The bank note processing machine of claim 1, further comprising a transmitter for transmitting at least one of the one or more supplied characteristics and the one or more determined characteristics to an information handling system.

8. A bank note processing method comprising:
processing a bundle of bank notes to generate one or more determined characteristics of the bundle of bank notes;
detecting information from an RFID chip associated with the bundle of bank notes;
obtaining one or more supplied characteristics of the bundle of bank notes based on the detected information from the RFID chip; and
comparing the one or more determined characteristics with the one or more supplied characteristics to obtain comparison information.

9. The method of claim 8, wherein at least one of the one or more determined characteristics and the one or more supplied characteristics comprises at least one of number of bank notes in the bundle of bank notes, denomination of bank notes in the bundle of bank notes and total amount of money in the bundle of bank notes.

10. The method of claim 8, further comprising reconciling an account based on the comparison between the one or more determined characteristics and the one or more supplied characteristics.

11. The method of claim 10, wherein reconciling the account comprises debiting an account of a sending entity of the bundle of bank notes if amount of money in the bundle of bank notes based on the determined characteristics is less than amount of money in the bundle of bank notes based on the supplied characteristics and crediting the account of the sending entity of the bundle of bank notes if the amount of money in the bundle of bank notes based on the determined characteristics is more than the amount of money in the bundle of bank notes based on the supplied characteristics.

12. The method of claim 8, wherein detected information from the RFID chip comprises at least one of the one or more supplied characteristics of the bundle of bank notes and a pointer to the one or more supplied characteristics of the bundle of bank notes.

13. The method of claim 12, wherein the pointer to the one or more supplied characteristics of the bundle of bank notes points to a computer readable medium of a central database.

14. The method of claim 8, wherein at least one of detecting information from the RFID chip, obtaining the one or more supplied characteristics of the bundle of bank notes and comparing the one or more determined characteristics with the one or more supplied characteristics is performed using a bank note processing machine comprising a central processor.

15. The method of claim 14, wherein the central processor generates comparison information by comparing the one or more determined characteristics of the bundle of bank notes with the one or more supplied characteristics of the bundle of bank notes.

16. The method of claim 14, wherein the central processor is operable to reconcile an account based on the comparison information.

17. The method of claim 8, further comprising transmitting at least one of the one or more supplied character and the comparison information to an information handling system.

18. The method of claim 8, wherein obtaining the one or more supplied characteristics of the bundle of bank notes based on the detected information from the RFID chip comprises:
providing a separator tag associated with the bundle of bank notes,
wherein the separator tag comprises the RFID chip containing the one or more supplied characteristics relating to the bundle of bank notes;
directing the separator tag and the bundle of bank notes through a bank note processing machine comprising an RFID reader; and
obtaining the one or more supplied characteristics from the RFID chip using the RFID reader.

19. The method of claim 18, wherein obtaining the one or more supplied characteristics from the RFID chip using the RFID reader comprises:
submitting a query from the RFID reader to the RFID chip;
transmitting the one or more supplied characteristics from the RFID chip to the RFID reader in response to the query; and
storing the one or more supplied characteristics in a computer-readable medium.

20. A system for tracking a bundle of bank notes comprising:
a feeder, wherein the feeder supplies a stack module to the system,
wherein the stack module comprises the bundle of bank notes and a separator tag having a RFID chip containing one or more supplied characteristics relating to the bundle of bank notes,
a transport device coupled to the feeder, wherein the transport device directs the separator tag and the bundle of bank notes through the system;
a RFID reader placed along the transport device, wherein the RFID reader submits a query to the bundle of bank notes and the separator tag as they are directed through the system by the transport device,
wherein in response to the query, the RFID chip transmits the one or more supplied characteristics to the RFID reader;
one or more detectors placed along the transport device,
wherein the one or more detectors detect one or more determined characteristics of the bundle of bank notes; and
a central processor, wherein the central processor controls operation of at least one of the feeder, the transport device, the RFID reader and the one or more detectors.
